(19) United States
(12) Patent Application Publication
(10) Pub. No.: US 2020/0325050 A1
(43) Pub. Date: Oct. 15, 2020

(54) Method and Device for Biological Waste Water Purification

(71) Applicant: Kurt INGERLE, Goetzens (AT)

(72) Inventor: Kurt INGERLE, Goetzens (AT)

(21) Appl. No.: 16/767,416

(22) PCT Filed: Oct. 1, 2018
(86) PCT No.: PCT/AT2018/060227

§ 371 Date: May 27, 2020

(30) Foreign Application Priority Data
Dec. 6, 2017 (AT) A 51011/2017

(51) Int. Cl. C02F 3/12; C02F 3/30

(52) U.S. Cl. CPC C02F 3/1263; C02F 3/1215; C02F 3/1284; C02F 2301/04; C02F 2203/006; C02F 2303/14; C02F 3/308

(57) ABSTRACT

The present invention relates to a method for carrying out biological purification of wastewater with the aid of activated sludge in a sewage treatment plant, the sewage treatment plant comprising: an activated sludge tank that can be ventilated (B tank), at least two sedimentation and recirculation tanks (SU tanks), and a tank for biological phosphor elimination (P tank), wherein the P tank is hydraulically connected with the B tank via one or more openings, wherein the B tank is divided into two tanks B₁ and B₂ (B₁ tank and B₂ tank) which are hydraulically connectable via the P tank, wherein each of the B₁ tank and the B₂ tank is continuously connected hydraulically to at least one SU tank, wherein the P tank comprises closure means to cut off the hydraulic connection between the P tank and the B₁ tank and/or the B₂ tank, and wherein each of the SU tanks comprises an overflow unit for draining the excess water in the sewage treatment plant, wherein in the event of an emergency, the hydraulic connection between the P tank and either the B₁ tank or the B₂ tank is cut off, and the waste water is then accumulated and lifted up in the tanks that are not cut off, and the treated wastewater can effluent via the overflow unit of the respective SU tank(s). The present invention also relates to a sewage treatment plant for carrying out said method.

The present invention relates to a method for carrying out biological purification of wastewater with the aid of activated sludge in a sewage treatment plant, which method allows for an emergency operation of the sewage treatment plant, the sewage treatment plant comprising:
an activated sludge tank that can be ventilated (hereinafter referred to as the B tank),
at least two sedimentation and recirculation tanks (hereinafter referred to as SU tanks), wherein the at least two SU tanks include at least one first sedimentation and recirculation tank (hereinafter referred to as SU₁ tank) and at least one second sedimentation and recirculation tank (hereinafter referred to as SU₂ tank), wherein the at least one SU₁ tank and the at least one SU₂ tank are continuously connected hydraulically to the B tank, wherein in the at least one SU₁ tank and in the at least SU₂ tank a number of operating cycles are carried out over the course of a day, including a sludge return phase, a recirculation phase, a pre-sedimentation phase and a draw-off phase (hereinafter referred to as the S phase, U phase, V phase, and A phase, respectively), and
a tank for biological phosphor elimination (hereinafter referred to as P tank), wherein the P tank is hydraulically connected with the B tank via one or more openings, and
wherein the volume of the P tank is mixed permanently or intermittently,
wherein in said method the wastewater is first introduced into the P tank and subsequently into the B tank, and then from the B tank, in alternation, into the at least one SU₁ tank and into the at least one the SU₂ tank,
wherein consecutively, in the S phase at least part of the thickened activated sludge is introduced from the at least one SU₁ tank and the at least one SU₂ tank, respectively, into the P tank, in the U phase the activated sludge is again mixed with the water, in the V phase the activated sludge is sedimented, and in the A phase treated water is drawn off, wherein in the at least one SU₁ tank and the at least one SU₂ tank said operating cycles are phase-shifted in relation to one another, the A phases in the at least one SU₁ tank and the at least one SU₂ tank border one another, a flow passes through the at least one SU₁ tank and the at least one SU₂ tank, respectively, merely in the A phases, an approximately constant water level is provided and therefore a wastewater treatment system discharge corresponding to the wastewater treatment system supply develops (“continuous flow” principle).

The present inventions also relates to a sewage treatment plant for carrying out biological purification of wastewater with the aid of activated sludge, which sewage treatment plant is suitable for carrying out the method of the present invention, wherein the sewage treatment plant comprises:
an activated sludge tank that can be ventilated (hereinafter referred to as the B tank),
at least two sedimentation and recirculation tanks (hereinafter referred to as SU tanks), wherein the at least two SU tanks include at least one first sedimentation and recirculation tank (hereinafter referred to as SU₁ tank) and at least one second sedimentation and recirculation tank (hereinafter referred to as SU₂ tank), wherein the at least one SU₁ tank and the at least one SU₂ tank are continuously connected hydraulically to the B tank, wherein in the at least one SU₁ tank and in the at least SU₂ tank a number of operating cycles are carried out over the course of a day, including a sludge return phase, a recirculation phase, a pre-sedimentation phase and a draw-off phase (hereinafter referred to as the S phase, U phase, V phase, and A phase, respectively), and
a tank for biological phosphor elimination (hereinafter referred to as P tank), wherein the P tank is hydraulically connected with the B tank via one or more openings, and wherein the volume of the P tank is mixed permanently or intermittently.

Methods and sewage treatment plants for carrying out biological purification of wastewater with the aid of activated sludge were previously described in WO 01/46075 A2. The methods and treatment plants described in WO 01/46075 A2 are known under the registered trademark BIOCOS, wherein more than 150 plants have been implemented so far. Methods and sewage treatment plants for carrying out biological purification of wastewater with the aid of activated sludge which, in addition, comprise a P tank for biological phosphor elimination are known from WO 2016/154646 A1.

It is usually very difficult to carry out repairs of one-line biological sewage treatment plants. With the help of specially designed P tanks it is possible to operate such sewage treatment plants in two-line operation in an emergency, but this is only possible at short-term and with a small sewage plant inflow, e.g. under dry weather conditions.

It is therefore an object of the present invention to provide a method for carrying out biological purification of wastewater with the aid of activated sludge in a sewage treatment plant, which method allows for an emergency operation of the sewage treatment plant in the event of an emergency, which emergency operation is easy to implement and to perform, without the need of shutting down the whole sewage treatment plant.

Another object of the present invention is to provide a sewage treatment plant for carrying out biological purification of wastewater with the aid of activated sludge, which sewage treatment plant is suitable for carrying out the method of the present invention and allows for an emergency operation of the sewage treatment plant in the event of an emergency, which emergency operation is easy to implement and to perform, without the need of shutting down the whole sewage treatment plant.

The present invention provides a solution to said objects by providing a method as mentioned above, which method is characterized in that the B tank is divided into two tanks B₁ and B₂ (hereinafter referred to as B₁ tank and B₂ tank) which are hydraulically connectable via the P tank, wherein each of the B₁ tank and the B₂ tank is continuously connected hydraulically to at least one SU tank in order to build up a one-line sewage treatment plant, wherein the P tank comprises closure means to cut off the hydraulic connection between the P tank and the B₁ tank and/or the B₂ tank, and wherein each of the SU tanks comprises an overflow unit for draining the excess water in the sewage treatment plant, wherein in said method, in the event of an emergency, the hydraulic connection between the P tank and either the B₁ tank or the B₂ tank is cut off, and the waste water is then accumulated and lifted up in the tanks that are not cut off, and the treated wastewater can effluent via the overflow unit of the respective SU tank(s).

The present invention also provides a sewage treatment plant as mentioned above, which is characterized in that the B tank is divided into two tanks B₁ and B₂ (hereinafter referred to as B₁ tank and B₂ tank) which are hydraulically connectable via the P tank, wherein each of the B₁ tank and the B₂ tank is continuously connected hydraulically to at least one SU tank, in order to build up a one-line sewage treatment plant, wherein the P tank comprises closure means to cut off the hydraulic connection between the P tank and the B₁ tank and/or the B₂ tank in events of emergency, and wherein each of the SU tanks comprises an overflow unit for draining the excess water in the sewage treatment plant.

The methods and sewage treatment plants of the present invention and as described herein allows for conducting repair of and maintenance work at tanks needing repair or maintenance work as well as for other measures that need to be taken during an event of emergency without the need of shutting down the whole sewage treatment plant.

The terms “emergency” and “event of emergency” as used herein relate to any kind of situation, in which one or more tanks of the sewage treatment plant have to be commissioned, shut down or emptied, e.g. in order to enable repair of or maintenance work at the tank(s) in question.

On the other hand, the term “full operation” as used herein, relates to any kind of situation in which all tanks, i.e. whole sewage treatment plant, are operating.

The feature, “that the activated sludge is introduced from the B tank which is divided into two tanks B₁ and B₂, in alternation, into the at least one SU₁ tank and into the at least one SU₂ tank” means that the activated sludge is transferred from the B tank in turn into the at least one SU₁ tank and into the at least one SU₂ tank; for example, the activated sludge may be first transferred from the B tank into the at least one SU₁ tank and then from the B tank into the at least one SU₂ tank, then into the at least one SU₁ tank and then into the at least one SU₂ tank and so on and so forth. Due to this, the operating cycles (each operating cycle encompasses an S phase, an U phase, a V phase, and an A phase; see description above) that take place in the at least one SU₁ tank and the at least one SU₂ tank are phase-shifted in relation to one another; in particular, the A phase taking place in the at least one SU₁ tank borders the A phase taking place in the at least one SU₂ tank.

The activity of microorganisms in a sewage treatment plant depends on the water temperature. The efficiency of a sewage treatment plant is therefore higher in summer than in winter. A similar effect is given by not yet full utilization of the treatment plant. In order to save space and costs, it is useful to take advantage of this effect. In summer (or with incomplete utilization), fewer wastewater treatment volumes are needed than in winter. In the summer, therefore, this volume can be used for a biological phosphorus elimination. For this purpose, the P tank, which—equipped with an aeration device—may act as a biological phosphor elimination in summer and may act as a B tank during winter. The P tank also serves to optimally distribute the incoming raw sewage and the recycled sludge into the B-tank system (i.e. B₁ and B₂ tanks). The aerated P tank also allows cascade operation. Thus, the P tank used in the methods and plants of the present invention is multifunctional.

Preferably, the B₁ tank and B₂ tank which are hydraulically connectable via the P tank have basically the same volume.

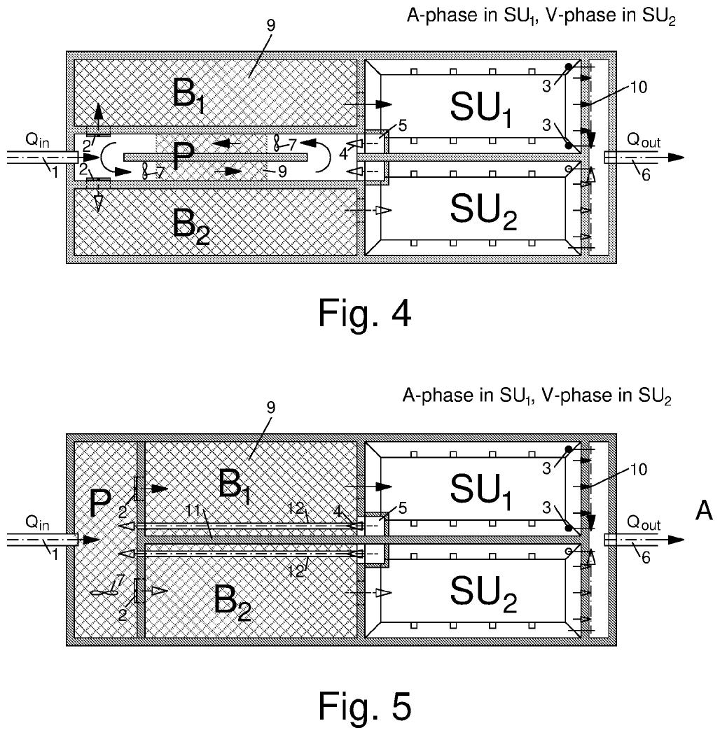

In one aspect of the method according to the invention, the P tank is positioned in the middle of the B tank and adjacent to the at least two SU tanks, and the P tank divides the B tank into the B₁ tank and the B₂ tank, wherein each of the B₁ tank and the B₂ tank is hydraulically connectable with the P tank via at least one closable opening, wherein in said method, in the event of an emergency, the hydraulic connection between the P tank and either the B₁ tank or the B₂ tank is cut off by closing the respective closable opening(s). Accordingly, in one aspect of the sewage treatment plant of the invention, the P tank is positioned in the middle of the B tank and adjacent to the at least two SU tanks, and the P tank divides the B tank into the B₁ tank and the B₂ tank, wherein each of the B₁ tank and the B₂ tank are hydraulically connectable with the P tank via at least one closable opening. Examples illustrating the principle of this aspect are shown in FIG. 2, FIG. 3, and FIG. 4.

In another aspect of the method according to the invention, the B tank is located between the P tank and the SU tanks, the B tank is divided into the B₁ tank and the B₂ tank by a wall, wherein each of the B₁ tank and the B₂ tank is hydraulically connectable with the P tank via at least one closable opening, wherein, in the S phase, the thickened activated sludge is transferred via one or more pipes from the at least one SU₁ tank and the at least one SU₂ tank, respectively, into the P tank, wherein in said method, in the event of an emergency, the hydraulic connection between the P tank and either the B₁ tank or the B₂ tank is cut off by closing the respective closable opening(s). Accordingly, in one aspect of the sewage treatment plant of the invention, the B tank is located between the P tank and the SU tanks, the B tank is divided into the B₁ tank and the B₂ tank by a wall, wherein each of the B₁ tank and the B₂ tank is hydraulically connectable with the P tank via at least one closable opening, wherein each SU tank is connected with one or more pipes which pipes are adapted to transfer the thickened activated sludge from the respective SU tank into the P tank. An example illustrating the principle of this aspect is shown in FIG. 5.

In a specific aspect of the aforementioned aspects, the B₁ tank is continuously connected hydraulically to one SU₁ tank and the B₂ tank is continuously connected hydraulically to one SU₂ tank, wherein in said method, in the event of an emergency, the hydraulic connection between the P tank and either the B₁ tank or the B₂ tank is cut off by closing the respective closable opening(s), in order to shut down either both the B₁ tank and SU₁ tank or both the B₂ tank and SU₂ tank, and the waste water is then accumulated and lifted up in the tanks that are not shut down, and the treated wastewater can effluent via the overflow unit of the respective SU tank that is not shut down. Accordingly, in this aspect of the sewage treatment plant of the invention, the B₁ tank is continuously connected hydraulically to one SU₁ tank and the B₂ tank is continuously connected hydraulically to one SU₂ tank. For exemplary purposes, reference is made to the specific arrangements of the tanks as shown in FIGS. 2-5.

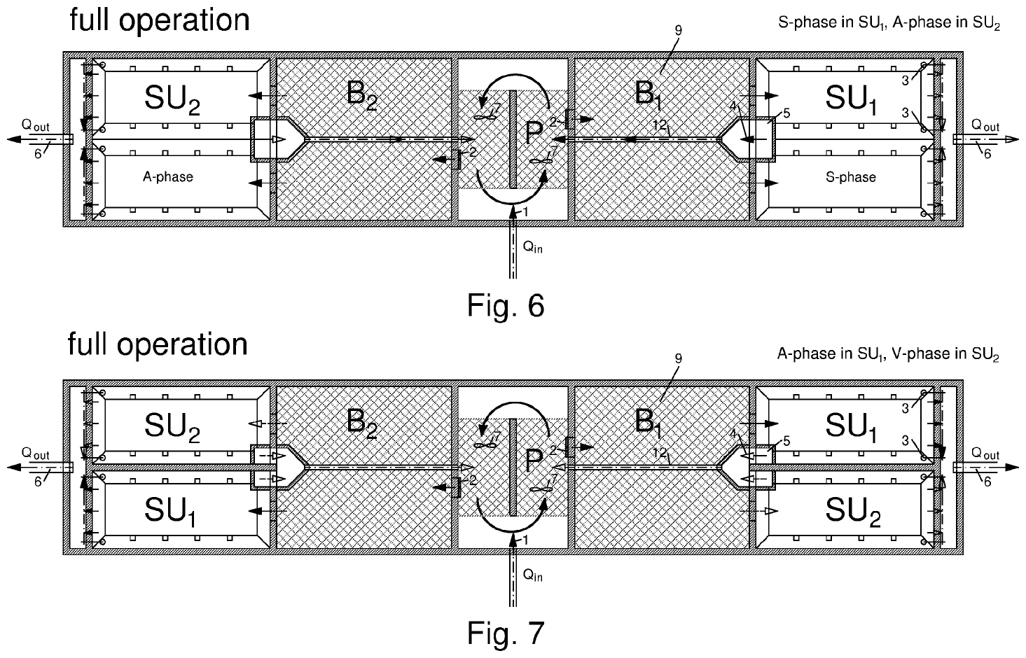

In another aspect of the method according to the invention, the P tank is positioned in the middle of the B tank and divides the B tank into the B₁ tank and the B₂ tank, wherein each of the B₁ tank and the B₂ tank is hydraulically connectable with the P tank via at least one closable opening, wherein the B₁ tank is positioned between the P tank and at least one SU tank and wherein the B₂ tank is positioned between the P tank and at least one SU tank, wherein in said method, in the event of an emergency, the hydraulic connection between the P tank and either the B₁ tank or the B₂ tank is cut off by closing the respective closable opening(s). Accordingly, in one aspect of the sewage treatment plant of the invention, the P tank is positioned in the middle of the B tank and divides the B tank into the B₁ tank and the B₂ tank, wherein each of the B₁ tank and the B₂ tank is hydraulically connectable with the P tank via at least one closable opening, wherein the B₁ tank is positioned between the P tank and at least one SU tank and wherein the B₂ tank is positioned between the P tank and at least one SU tank. Examples illustrating the principle of this aspect are shown in FIG. 6 and FIG. 7.

In a specific aspect of the aforementioned aspect, the B₁ tank is continuously connected hydraulically to one SU₁ tank, and the B₂ tank is continuously connected hydraulically to one SU₂ tank, wherein in said method, in the event of an emergency, the hydraulic connection between the P tank and either the B₁ tank or the B₂ tank is cut off by closing the respective closable opening(s), in order to shut down either both the B₁ tank and SU₁ tank or both the B₂ tank and SU₂ tank, and the waste water is then accumulated and lifted up in the tanks that are not shut down, and the treated wastewater can effluent via the overflow unit of the respective SU tank that is not shut down. Accordingly, in a specific aspect of the sewage treatment plant of the invention, the B₁ tank is continuously connected hydraulically to one SU₁ tank, and the B₂ tank is continuously connected hydraulically to one SU₂ tank. For exemplary purposes, reference is made to the specific arrangement of the tanks as per the embodiment shown in FIG. 6.

In another specific aspect of the aforementioned aspect, the B₁ tank is continuously connected hydraulically to one SU₁ tank and one SU₂ tank (hereinafter referred to as “tanks B₁-SU₁-SU₂”), and the B₂ tank is continuously connected hydraulically to one SU₁ tank and one SU₂ tank (hereinafter referred to as “tanks B₂-SU₁-SU₂”), wherein in said method, in the event of an emergency, the hydraulic connection between the P tank and either the B₁ tank or the B₂ tank is cut off by closing the respective closable opening(s), which leads to a shut-down of either tanks B₁-SU₁-SU₂ or tanks B₂-SU₁-SU₂, and the waste water is then accumulated and lifted up in the tanks that are not shut down, and the treated wastewater level can ascent up to the upper edge of the overflow unit of the respective SU tanks that are not shut down. Accordingly, in a specific aspect of the sewage treatment plant of the invention, the B₁ tank is continuously connected hydraulically to one SU₁ tank and one SU₂ tank (hereinafter referred to as “tanks B₁-SU₁-SU₂”), and the B₂ tank is continuously connected hydraulically to one SU₁ tank and one SU₂ tank (hereinafter referred to as “tanks B₂-SU₁-SU₂”). For exemplary purposes, reference is made to the specific arrangement of the tanks as per the embodiment shown in FIG. 7.

Preferably, the excess sludge is pumped from the SU tanks into the P tanks via airlifts and at least two pipes.

In one aspect of the method according to the invention, during full operation of all tanks, in the S-phase, the thickened activated sludge is largely channeled into the B₁ tank and the B₂ tank, respectively and the P tank primarily has the task to divide the incoming wastewater to B₁ and B₂.

In one aspect of the method according to the invention, the P tank is aerated and, optionally, also the B₁ tank and the B₂ tank.

In one aspect of the method and the sewage treatment plant according to the invention, the P tank comprises aeration and/or stirring units that are removable for repairs.

In one aspect of the method according to the invention, the tanks that are cut off in the case of an emergency, are emptied for a short time, e.g. for repair, while at the same time the biological purification of wastewater is operated with the tanks that are not shut down.

In one aspect of the method according to the invention, in full operation of all tanks the aeration in the P tank is activated and a biological phosphorus elimination is dispensed with.

In one aspect of the method according to the invention, in full operation of all tanks the aeration in the P tank is switched off and the biological phosphorus elimination goes into operation.

In one aspect of the method according to the invention, the contents of the P tank are mixed permanently or intermittently with a stirring system.

In one aspect of the method and the sewage treatment plant according to the invention, the P tank is constructed in form of a circulation tank.

In another aspect of the method according to the invention, in the event of an emergency, an agent for enhancing sludge sedimentation, preferably a flocculant, is added to one or more of the tanks that are not cut off, i.e. the one or more tanks that are still in operation. The addition of an agent for enhancing the sedimentation of the activated sludge, preferably a flocculant, enhances the hydraulic capacity of the tanks that are still in operation. The agent for enhancing the sedimentation of the activated sludge is preferably a flocculant. Flocculants used in sewage treatment and sludge sedimentation are well-known in the art, for example flocculants based on calcium hydroxide.

Alternatively or in addition to adding an agent for enhancing sludge sedimentation, the hydraulic capacity of the tanks being still in operation in the event of an emergency can also be enhanced by removing excess sludge from the SU tank(s) that is/are not cut off. Preferably the excess sludge is removed at ground level from said SU tank(s), more preferably from a distance of about 1 m above the ground of the SU tank(s). If the respective SU tank comprises an airlift unit, which is typically located at or close to a side wall of the SU tank, the excess sludge is preferably removed at ground level, preferably at about 1 m above the ground of the SU tank, in a certain distance from the airlift unit, e.g. near a side wall of the SU tank that is opposite the side wall where the airlift unit is located.

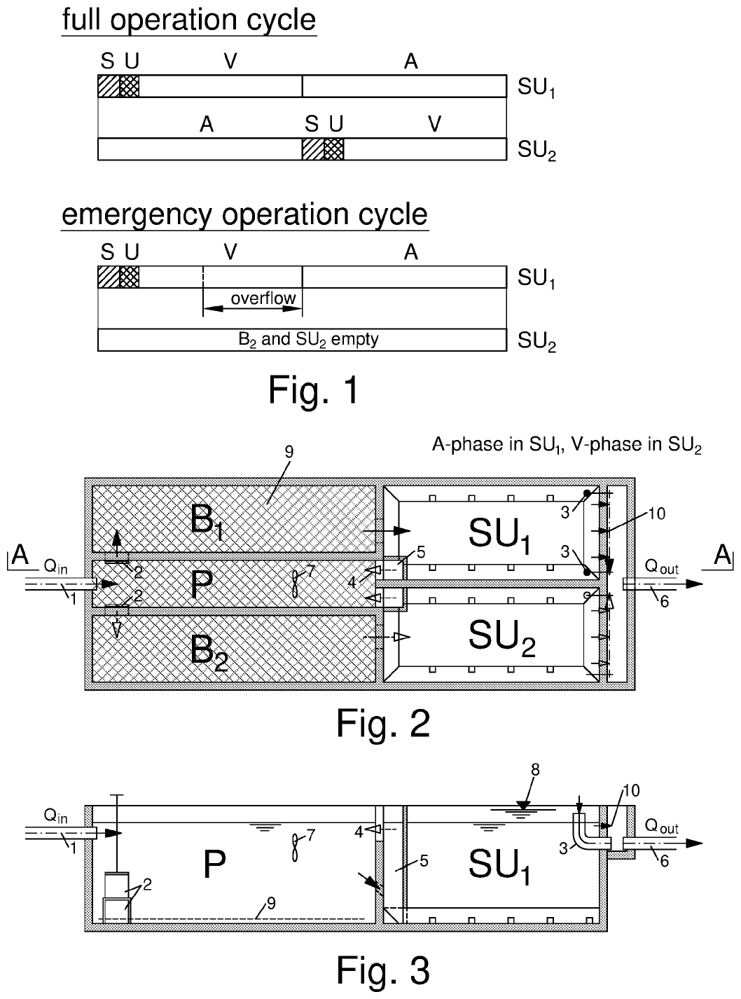

Further details of the present invention will emerge from the following drawings, which illustrate exemplary, non-limiting embodiments of the invention. In the drawings, two operating cycles (FIG. 1) and different exemplary embodiments of wastewater treatment systems (FIG. 2-FIG. 7) according to the present invention are shown.

FIG. 1 shows two operating cycles (full operation cycle and emergency operation cycle) for the SU tanks SU₁ and SU₂ shown in the exemplary embodiments of FIGS. 2-6 and a possible operation of the overflow 3;

FIG. 2 shows a schematic illustration of a first embodiment of the present invention (top view);

FIG. 3 shows a vertical sectional view of the embodiment of FIG. 2;

FIG. 4 shows a schematic illustration of a second embodiment of the present invention (top view), with a P tank in form of a circulation tank (top view);

FIG. 5 shows a schematic illustration of a third embodiment of the present invention (top view);

FIG. 6 shows a schematic illustration of a fourth embodiment of the present invention (top view);

FIG. 7 shows a schematic illustration of a fifth embodiment of the present invention (top view).

As mentioned above, the activity of microorganisms in a sewage treatment plant depends on the water temperature. The efficiency of a sewage treatment plant is therefore higher in summer than in winter. A similar effect is given by not yet full utilization of the treatment plant. In order to save space and costs, it is useful to take advantage of this effect. In summer (or with incomplete utilization), fewer wastewater treatment volumes are needed than in winter. In the summer, therefore, this volume can be used for a biological phosphorus elimination. For this purpose, the P tank described in FIGS. 2-7, which—equipped with an aeration device—may act as a biological phosphor elimination in summer and may act as a B tank during winter. The P tank also serves to optimally distribute the incoming raw sewage and the recycled sludge into the B tank system (i.e. B₁ and B₂ tanks). The aerated P tank also allows cascade operation. Thus, the P tank as used in this invention and described in the embodiments of accompanying FIGS. 2-7 is multifunctional.

FIG. 1 shows the operating cycle for the SU tanks SU₁ and SU₂ shown as per the exemplary embodiments of FIGS. 2-6, wherein time extends in horizontal direction from left to right. The course and function of the individual phases, i.e. S phase, U phase, V phase and A phase, taking place in the respective SU tanks, have already been discussed above in greater detail. In this figure “a full operation cycle” and an “emergency operation cycle” and a possible operation of the overflow unit (see FIGS. 2-6, overflow unit 3 of the SU tanks) are shown. The “emergency operation cycle” illustrates the course and function of the phases, when the B₂ tank and SU₂ tank of the embodiments shown in FIGS. 2-6 have been shut down and emptied due to an event of emergency (e.g. if the B₂ or SU₂ tank needs repair or maintenance work).

FIG. 2 shows a schematic illustration of a wastewater treatment system, in which two SU tanks SU₁ and SU₂ are arranged side by side on one side of the B tank and adjacent to the P tank. The B tank is divided into a B₁ tank and B₂ tank by the P tank. In this illustration, currently an A-phase takes place in the SU₁ tank, wherein in the SU₂ tank, a V-phase takes place (description of the different phases, see above). The flow of the wastewater in the P tank is signified with 1 and the flow out of the system with 6. The thickened activated sludge 4 is transferred from the SU tanks to the P tank with airlifts 5 (during the S-phase). The hydraulic connection and water flow from the P tank to the B₁ and B₂ tanks is realized by means of closable openings 2. The closable openings comprise flat slides to cut off the hydraulic connection between the P tank and the B₁ tank or the B₂ tank in events of emergency. The contents of the P tank can also be homogenized with a stirring device 7. Both the B-tank and the P tank are supplied with aeration 9.

In the “full operation” the closable openings 2 between the P tank and the B₁ tank and B₂ tank, respectively, are open and all tanks are in operation with an approximate constant water level (throughflow-principle). This one-line system can be in operation with or without a biological phosphor elimination. In this case, the overflow units 3 which are part of the SU tanks is not needed. If the aeration 9 in the P tank is in action, a cascade method is achieved.

In the “emergency operation” part of the tanks, i.e. either B₁ and SU₁ or B₂ and SU₂, can be taken out of service and emptied by closing the respective closable opening 2 (either between P tank and B₁ tank or between P tank and B₂ tank) by means of the slide. In other words, the hydraulic connection between the P tank and the B₁ tank or the B₂ tank is closed, leading to a cut-off/shut-down of either the B₁ and SU₁ tanks or B₂ and SU₂ tanks. In this case, the water level rises in the S-, U- and first half of the V-phase. As the water level rises, the sludge settles in the SU-tank that is not shut down. After approximately 30 min, the water level reaches the level of the emergency overflow unit 3 of the SU tank that is not taken out of service, treated wastewater without the sludge can drain off and a maximum height of the water level is not exceeded. In the subsequent A-phase, an effluent device 10 opens, whereby the water level assumes a lower level. In this case we speak of “filling up principle”.

FIG. 3 shows a vertical sectional view of the system of FIG. 2 (along a line which, in FIG. 2, extends between A-A). Qₘ signifies the flow of the wastewater introduced into the P tank, wherein Qₒᵤₜ is the flow of the treated water flowing off from the water treatment system. The thickened activated and aerated sludge 4 is transferred from the SU tanks SU₁ and SU₂ into the P tank via e.g. a pipe. In order to mix the waste water in the P tank efficiently with the thickened activated sludge 4, the volume of the P tank is mixed permanently or intermittently. The mixture of waste water and sludge is then transferred into the B tank and further to the SU tanks SU₁ and SU₂ via the one or more closable openings 2 connecting the P tank with the B₁ tank and B₂ tank as described above. For transferring the waste water from the B₁ tank and the B₂ tank to the SU tanks SU₁ and SU₂, respectively, one or more closable openings are also provided between the B₁ tank and the SU₁ tank as well as between the B₂ tank and the SU₂ tank; see FIG. 2. 5 signifies the airlift operation unit for operation of the S phase. A maximum height of the water level 8 is not exceeded.

FIG. 4 shows a schematic illustration of a second embodiment of the present invention (top view). The second embodiment fully corresponds to the embodiment as shown in FIGS. 2 and 3, with the only exception that the P tank is in form of a circulation tank. As in FIGS. 2 and 3, also in this illustration, currently an A-phase takes place in the SU₁ tank, wherein in the SU₂ tank, a V-phase takes place (description of the different phases, see above).

FIG. 5 shows a schematic illustration of a third embodiment of the present invention (top view). The arrangement of the P, B and SU tanks in this embodiment is slightly different from the arrangement shown in FIGS. 2-4 as described above, but the applied “full operation” mode and “emergency operation” mode as described above in relation to FIGS. 2-4 apply, mutatis mutandis, to the embodiment of FIG. 5. Features in FIG. 5 are provided with the same reference signs as the corresponding features already described above in relation to the embodiments shown in FIGS. 2-4.

In the embodiment shown in FIG. 5, the B tank is located between the P tank and the SU tanks, the B tank is divided into the B₁ tank and the B₂ tank by a wall 11, wherein each of the B₁ tank and the B₂ tank is hydraulically connectable with the P tank via at least one closable opening 2. In the S phase, the thickened activated sludge is transferred via one or more pipes 12 from the SU₁ tank and the SU₂ tank, respectively, into the P tank, wherein in said method, in the event of an emergency, the hydraulic connection between the P tank and either the B₁ tank or the B₂ tank is cut off by closing the respective closable opening(s) 2.

As in the embodiments shown in FIGS. 2-4, also in the embodiment of FIG. 5, the B₁ tank is continuously connected hydraulically to the SU₁ tank and the B₂ tank is continuously connected hydraulically to the SU₂ tank, wherein in the event of an emergency, the hydraulic connection between the P tank and either the B₁ tank or the B₂ tank is cut off by closing the respective closable opening(s) 2, in order to shut down either both the B₁ tank and SU₁ tank or both the B₂ tank and SU₂ tank, and the waste water is then accumulated and lifted up in the tanks that are not shut down, and the treated wastewater can effluent via the overflow unit 3 of the respective SU tank that is not shut down.

FIG. 6 shows a schematic illustration of a fourth embodiment of the present invention (top view). The arrangement of the P, B and SU tanks in this embodiment is different from the arrangements as described above, but the applied “full operation” mode and “emergency operation” mode as described above in relation to FIGS. 2-4 apply, mutatis mutandis, for the arrangement of FIG. 6. Features in FIG. 6 are provided with the same reference signs as the corresponding features already described above in relation to the embodiments shown in FIGS. 2-4.

In the embodiment shown in FIG. 6 the P tank is positioned in the middle of the B tank and divides the B tank into the B₁ tank and the B₂ tank, wherein each of the B₁ tank and the B₂ tank is hydraulically connectable with the P tank via at least one closable opening 2, wherein the B₁ tank is positioned between the P tank and the SU₁ tank and wherein the B₂ tank is positioned between the P tank and the SU₂ tank, wherein in said method, in the event of an emergency, the hydraulic connection between the P tank and either the B₁ tank or the B₂ tank is cut off by closing the respective closable opening(s) 2. In the embodiment of FIG. 6, the B₁ tank is continuously connected hydraulically to the SU₁ tank, and the B₂ tank is continuously connected hydraulically to the SU₂ tank, wherein, in the event of an emergency, the hydraulic connection between the P tank and either the B₁ tank or the B₂ tank is cut off by closing the respective closable opening(s) 2, in order to shut down either both the B₁ tank and SU₁ tank or both the B₂ tank and SU₂ tank, and the waste water is then accumulated and lifted up in the tanks that are not shut down, and the treated wastewater can effluent via the overflow unit 3 of the respective SU tank that is not shut down.

The P tank of FIG. 6 has the form of a circulation tank. The flow of the wastewater in the P tank is signified with 1 and the flow of the treated water out of the system with 6. The thickened activated sludge 4 is pumped from the SU₁ and SU₂ tanks into the P tank by means of airlifts 5 and pipes 12.

FIG. 7 shows a schematic illustration of a fifth embodiment of the present invention (top view). The arrangement of the P, B and SU tanks in this embodiment is different from the arrangements as described above, but the applied “full operation” mode and “emergency operation” mode as described above in relation to FIGS. 2-4 apply, mutatis mutandis, for the arrangement of FIG. 7. Features in FIG. 7 are provided with the same reference signs as the corresponding features already described above in relation to the embodiments shown in FIGS. 2-4.

In the embodiment shown in FIG. 7 the P tank is positioned in the middle of the B tank and divides the B tank into the B₁ tank and the B₂ tank, wherein each of the B₁ tank and the B₂ tank is hydraulically connectable with the P tank via at least one closable opening 2, wherein the B₁ tank is positioned between the P tank and one SU₁ tank and one SU₂ tank and wherein the B₂ tank is positioned between the P tank and one SU₁ tank and one SU₂ tank, wherein, in the event of an emergency, the hydraulic connection between the P tank and either the B₁ tank or the B₂ tank is cut off by closing the respective closable opening(s) 2. Accordingly, in the embodiment shown in FIG. 7, the B₁ tank is continuously connected hydraulically to one SU₁ tank and one SU₂ tank (hereinafter referred to as “tanks B₁-SU₁-SU₂”), and the B₂ tank is continuously connected hydraulically to one SU₁ tank and one SU₂ tank (hereinafter referred to as “tanks B₂-SU₁-SU₂”), wherein, in the event of an emergency, the hydraulic connection between the P tank and either the B₁ tank or the B₂ tank is cut off by closing the respective closable opening(s) 2, which leads to a shut-down of either tanks B₁-SU₁-SU₂ or tanks B₂-SU₁-SU₂, and the waste water is then accumulated and lifted up in the tanks that are not shut down, and the treated wastewater level can ascent up to the upper edge of the overflow unit of the respective SU tanks that are not shut down.

The P tank of FIG. 7 has the form of a circulation tank. The flow of the wastewater in the P tank is signified with 1 and the flow of the treated water out of the system with 6. The thickened activated sludge 4 is pumped from the SU₁ and SU₂ tanks (i.e. a total of four SU tanks) into the P tank by means of airlifts 5 and pipes 12.

In the embodiments illustrated in FIGS. 2-7, only one closable opening 2 that hydraulically connects the P tank with the B₁ tank as well as the P tank with the B₂ tank is shown in the drawings. It will, however, be clear to the skilled person, that more than one closable opening 2 between the P tank and the B₁ tank as well as between the P tank and the B₂ tank may be foreseen.

1. A method for carrying out biological purification of wastewater with the aid of activated sludge in a sewage treatment plant, which method allows for an emergency operation of the sewage treatment plant, the sewage treatment plant comprising:
an activated sludge tank that can be ventilated (hereinafter referred to as the B tank),
at least two sedimentation and recirculation tanks (hereinafter referred to as SU tanks), wherein the at least two SU tanks include at least one first sedimentation and recirculation tank (hereinafter referred to as SU1 tank) and at least one second sedimentation and recirculation tank (hereinafter referred to as SU2 tank), wherein the at least one SU1 tank and the at least one SU2 tank are continuously connected hydraulically to the B tank, wherein in the at least one SU1 tank and in the at least SU2 tank a number of operating cycles are carried out over the course of a day, including a sludge return phase, a recirculation phase, a pre-sedimentation phase and a draw-off phase (hereinafter referred to as the S phase, U phase, V phase, and A phase, respectively), and
a tank for biological phosphor elimination (hereinafter referred to as P tank), wherein the P tank is hydraulically connected with the B tank via one or more openings, and wherein the volume of the P tank is mixed permanently or intermittently,
wherein in said method the wastewater is first introduced into the P tank and subsequently into the B tank, and then from the B tank, in alternation, into the at least one SU1 tank and into the at least one the SU2 tank,
wherein consecutively, in the S phase at least part of the thickened activated sludge is introduced from the at least one SU1 tank and the at least one SU2 tank, respectively, into the P tank, in the U phase the activated sludge is again mixed with the water, in the V phase the activated sludge is sedimented, and in the A phase treated water is drawn off, wherein in the at least one SU1 tank and the at least one SU2 tank said operating cycles are phase-shifted in relation to one another, the A phases in the at least one SU1 tank and the at least one SU2 tank border one another, a flow passes through the at least one SU1 tank and the at least one SU2 tank, respectively, merely in the A phases, an approximately constant water level is provided and therefore a wastewater treatment system discharge corresponding to the wastewater treatment system supply develops (“continuous flow” principle),
wherein:
the B tank is divided into two tanks B1 and B2 (hereinafter referred to as B1 tank and B2 tank) which are hydraulically connectable via the P tank, wherein each of the B1 tank and the B2 tank is continuously connected hydraulically to at least one SU tank in order to build up a one-line sewage treatment plant, wherein the P tank comprises closure means to cut off the hydraulic connection between the P tank and the B1 tank and/or the B2 tank, and wherein each of the SU tanks comprises an overflow unit for draining the excess water in the sewage treatment plant,
wherein in said method, in the event of an emergency, the hydraulic connection between the P tank and either the B1 tank or the B2 tank is cut off, and the waste water is then accumulated and lifted up in the tanks that are not cut off, and the treated wastewater can effluent via the overflow unit of the respective SU tank(s).

2. The method according to claim 1, wherein the P tank is positioned in the middle of the B tank and adjacent to the at least two SU tanks, and the P tank divides the B tank into the B1 tank and the B2 tank, wherein each of the B1 tank and the B2 tank is hydraulically connectable with the P tank via at least one closable opening, wherein in said method, in the event of an emergency, the hydraulic connection between the P tank and either the B1 tank or the B2 tank is cut off by closing the respective closable opening(s).

3. The method according to claim 1, wherein the B tank is located between the P tank and the SU tanks, the B tank is divided into the B1 tank and the B2 tank by a wall, wherein each of the B1 tank and the B2 tank is hydraulically connectable with the P tank via at least one closable opening, wherein, in the S phase, the thickened activated sludge is transferred via one or more pipes from the at least one SU1 tank and the at least one SU2 tank, respectively, into the P tank, wherein in said method, in the event of an emergency, the hydraulic connection between the P tank and either the B1 tank or the B2 tank is cut off by closing the respective closable opening(s).

4. The method according to claim 2, wherein the B1 tank is continuously connected hydraulically to one SU1 tank and wherein the B2 tank is continuously connected hydraulically to one SU2 tank, wherein in said method, in the event of an emergency, the hydraulic connection between the P tank and either the B1 tank or the B2 tank is cut off by closing the respective closable opening(s), in order to shut down either both the B1 tank and SU1 tank or both the B2 tank and SU2 tank, and the waste water is then accumulated and lifted up in the tanks that are not shut down, and the treated wastewater can effluent via the overflow unit of the respective SU tank that is not shut down.

5. The method according to claim 1, wherein the P tank is positioned in the middle of the B tank and divides the B tank into the B1 tank and the B2 tank, wherein each of the B1 tank and the B2 tank is hydraulically connectable with the P tank via at least one closable opening, wherein the B1 tank is positioned between the P tank and at least one SU tank and wherein the B2 tank is positioned between the P tank and at least one SU tank, wherein in said method, in the event of an emergency, the hydraulic connection between the P tank and either the B1 tank or the B₂ tank is cut off by closing the respective closable opening(s).

6. The method according to claim 5, wherein the B1 tank is continuously connected hydraulically to one SU1 tank, and the B2 tank is continuously connected hydraulically to one SU2 tank, wherein in said method, in the event of an emergency, the hydraulic connection between the P tank and either the B1 tank or the B2 tank is cut off by closing the respective closable opening(s), in order to shut down either both the B1 tank and SU1 tank or both the B2 tank and SU2 tank, and the waste water is then accumulated and lifted up in the tanks that are not shut down, and the treated wastewater can effluent via the overflow unit of the respective SU tank that is not shut down.

7. The method according to claim 5, wherein the B1 tank is continuously connected hydraulically to one SU1 tank and one SU2 tank (hereinafter referred to as “tanks B1-SU1-SU2”), and the B2 tank is continuously connected hydraulically to one SU1 tank and one SU2 tank (hereinafter referred to as “tanks B2-SU1-SU2”), wherein in said method, in the event of an emergency, the hydraulic connection between the P tank and either the B1 tank or the B2 tank is cut off by closing the respective closable opening(s), which leads to a shut-down of either tanks B1-SU1-SU2 or tanks B2-SU1-SU2, and the waste water is then accumulated and lifted up in the tanks that are not shut down, and the treated wastewater level can ascent up to the upper edge of the overflow unit of the respective SU tanks that are not shut down.

8. The method according to claim 5, wherein the excess sludge is pumped from the SU tanks into the P tanks via airlifts and at least two pipes.

9. The method according claim 3, wherein, during the full operation phase, in the S-phase, the thickened activated sludge is largely channeled into the B1 tank and the B2 tank, respectively and the P tank primarily has the task to divide the incoming wastewater to B1 and B2.

10. The method according to claim 1, wherein the P tank is aerated and, optionally, also the B1 tank and the B2 tank.

11. The method according to claim 1, wherein the P tank comprises aeration and/or stirring units that are removable for repairs.

12. The method according to claim 1, wherein the tanks that are cut off in the case of an emergency, are emptied for a short time, e.g. for repair, while at the same time the biological purification of wastewater is operated with the tanks that are not shut down.

13. The method according to claim 1, wherein in full operation of all tanks the aeration in the P tank is activated and a biological phosphorus elimination is dispensed with.

14. The method according to claim 1, wherein in full operation of all tanks the aeration in the P tank is switched off and the biological phosphorus elimination goes into operation.

15. The method according to claim 1, wherein the contents of the P tank are mixed permanently or intermittently with a stirring system.

16. The method according to claim 1, wherein the P tank is constructed in a form of a circulation tank.

17. The method according to claim 1, wherein, in the event of an emergency, an agent for enhancing sludge sedimentation, preferably a flocculant, is added to one or more of the tanks that are not cut off.

18. The method according to claim 1, wherein, in the event of an emergency, the excess sludge is removed from the SU tank(s) that is/are not cut off.

19. A sewage treatment plant for carrying out biological purification of wastewater with the aid of activated sludge (4), wherein the sewage treatment plant comprises:
an activated sludge tank that can be ventilated (hereinafter referred to as the B tank),
at least two sedimentation and recirculation tanks (hereinafter referred to as SU tanks), wherein the at least two SU tanks include at least one first sedimentation and recirculation tank (hereinafter referred to as SU1 tank) and at least one second sedimentation and recirculation tank (hereinafter referred to as SU2 tank), wherein the at least one SU1 tank and the at least one SU2 tank are continuously connected hydraulically to the B tank, wherein the sewage treatment plant is configured such that in the at least one SU1 tank and in the at least SU2 tank a number of operating cycles are carried out over the course of a day, including a sludge return phase, a recirculation phase, a pre-sedimentation phase and a draw-off phase (hereinafter referred to as the S phase, U phase, V phase, and A phase, respectively), and
a tank for biological phosphor elimination (hereinafter referred to as P tank), wherein the P tank is hydraulically connected with the B tank via one or more openings (2), and wherein the volume of the P tank is mixed permanently or intermittently,
wherein:
the B tank is divided into two tanks B1 and B2 (hereinafter referred to as B1 tank and B2 tank) which are hydraulically connectable via the P tank, wherein each of the B1 tank and the B2 tank is continuously connected hydraulically to at least one SU tank, in order to build up a one-line sewage treatment plant,
wherein the P tank comprises closure means to cut off the hydraulic connection between the P tank and the B1 tank and/or the B2 tank in events of emergency, and wherein each of the SU tanks comprises an overflow unit for draining the excess water in the sewage treatment plant.

20. The sewage treatment plant according to claim 19, wherein the P tank is positioned in the middle of the B tank and adjacent to the at least two SU tanks, and the P tank divides the B tank into the B1 tank and the B2 tank, wherein each of the B1 tank and the B2 tank are hydraulically connectable with the P tank via at least one closable opening (2).

21. The sewage treatment plant according to claim 19, wherein the B tank is located between the P tank and the SU tanks, the B tank is divided into the B1 tank and the B2 tank by a wall (11), wherein each of the B1 tank and the B2 tank is hydraulically connectable with the P tank via at least one closable opening, wherein each SU tank is connected with one or more pipes (12) which pipes are adapted to transfer the thickened activated sludge (4) from the respective SU tank into the P tank.

22. The sewage treatment plant according to claim 20, wherein the B1 tank is continuously connected hydraulically to one SU1 tank and wherein the B2 tank is continuously connected hydraulically to one SU2 tank.

23. The sewage treatment plant according to claim 19, wherein the P tank is positioned in the middle of the B tank and divides the B tank into the B1 tank and the B2 tank, wherein each of the B1 tank and the B2 tank is hydraulically connectable with the P tank via at least one closable opening (2), wherein the B1 tank is positioned between the P tank and at least one SU tank and wherein the B2 tank is positioned between the P tank and at least one SU tank.

24. The sewage treatment plant according to claim 23, wherein the B1 tank is continuously connected hydraulically to one SU1 tank, and the B2 tank is continuously connected hydraulically to one SU2 tank.

25. The sewage treatment plant according to claim 23, wherein the B1 tank is continuously connected hydraulically to one SU1 tank and one SU2 tank (hereinafter referred to as “tanks B1-SU1-SU2”), and the B2 tank is continuously connected hydraulically to one SU1 tank and one SU2 tank (hereinafter referred to as “tanks B2-SU1-SU2”).

26. The sewage treatment plant according to claim 19, wherein the P tank comprises aeration and/or stirring units (7) that can be removed for repairs.

27. The sewage treatment plant according to claim 19, wherein the P tank is constructed in a form of a circulation tank.
